(19) United States
(12) Patent Application Publication
(10) Pub. No.: US 2026/0348907 A1
(43) Pub. Date: Nov. 5, 2026

(54) SYSTEMS AND METHODS FOR ANALYZING MICROVOLUME SAMPLE

(71) Applicant: Thermo Electron Scientific Instruments LLC, Madison, WI (US)

(72) Inventors: John Eichorst, Verona, WI (US); Brian Matlock, Lincoln University, PA (US); Kannan Srinivasan, Chelmsford, MA (US); Damian Ashmead, Middletown, DE (US)

(21) Appl. No.: 19/157,139

(22) PCT Filed: Feb. 16, 2024
(86) PCT No.: PCT/US2024/016089

§ 371 Date: Aug. 15, 2025

Related U.S. Application Data
(60) Provisional application No. 63/485,774, filed on Feb. 17, 2023.

(51) Int. Cl. G01N 27/416; G01N 21/01

(52) U.S. Cl. CPC G01N 27/4167; G01N 21/01

(57) ABSTRACT

Systems and methods for analyzing a liquid sample. One system includes a first surface including at least a part of a first electrode and a second surface including at least a part of a second electrode. The second surface is positioned opposite the first surface for holding a microvolume liquid sample between the first surface and the second surface by surface tension. The system also includes an electronic processing unit electrically coupled to at least one of the first electrode and the second electrode for receiving electrical signals from the liquid sample to measure an electrochemical property of the liquid sample.

### CROSS-REFERENCE TO RELATED APPLICATIONS

This application claims the benefit of and priority to U.S. Provisional Application no. U.S. 63/485,774, filed on Feb. 17, 2023. The entire contents of the aforementioned application are incorporated by reference herein.

### FIELD OF THE INVENTION

Embodiments described herein generally relate to systems and methods for analyzing a liquid sample, and more particular to measuring properties of a microvolume liquid sample held between two surfaces by surface tension.

### SUMMARY

In one embodiment, a system for analyzing a sample comprises a first surface including at least a part of a first electrode; a second surface including at least a part of a second electrode, the second surface positioned opposite the first surface for holding the sample between the first surface and the second surface by surface tension; and an electronic processing unit coupled to at least one of the first electrode and the second electrode for receiving electrical signals from the sample to measure an electrochemical property of the sample.

In another embodiment, a method for measuring an electrochemical property of a sample comprises positioning the sample between a first surface and a second surface, wherein the sample is held between the first and second surfaces via surface tension, and a least an electrically conductive part of each of the first surface and the second surface is in direct contact with the liquid sample; receiving electrical signals from the sample at the electrically conductive part of at least one of the first surface and the second surface; and determining the electrochemical property of the sample based on the received electrical signals.

In another embodiment, a system for analyzing a liquid sample comprises a first surface including at least a part of a first electrode; a second surface including at least a part of a second electrode, the second surface positioned opposite the first surface for holding a microvolume liquid sample between the first surface and the second surface by surface tension; an actuator for adjusting a distance between the first surface and the second surface; a controller including a processor and a non-transitory memory for storing computer readable instructions, by executing the instructions in the processor, the controller is configured to: adjust, via the actuator, the distance between the first surface and the second surface to a measurement separation distance; receive an electrical signal from the liquid sample; and determine an electrochemical property of the sample based on the received electrical signal.

It should be understood that the summary above is provided to introduce in simplified form a selection of concepts that are further described in the detailed description. It is not meant to identify key or essential features of the claimed subject matter, the scope of which is defined uniquely by the claims that follow the detailed description.

### BRIEF DESCRIPTION OF THE DRAWINGS

FIG. 1A is a block diagram of a liquid analysis system according to various embodiments.

FIG. 1B is a block diagram of a controller included in the liquid analysis system of FIG. 1A according to various embodiments.

FIG. 2 is a block diagram of a liquid analysis system including a visible light-emitting device, according to various embodiments.

FIG. 3 is a flowchart illustrating a method for measuring electrochemical properties of a sample using the system shown FIGS. 1A-1B and FIG. 2.

FIG. 4 is a flowchart illustrating an example initialization process of FIG. 3.

FIG. 5 is a flowchart illustrating an example calibration process of FIG. 3.

FIG. 6 is a flowchart illustrating an example measurement process of FIG. 3.

FIG. 7 illustrates an example pedestal reference library and pedestal lookup table associated with the initialization process of FIG. 4.

FIG. 8A illustrates image registration according to various embodiments.

FIG. 8B illustrates a kernel of an image and processing thereof according to various embodiments.

FIG. 9A is a graph illustrating measured conductivity values for different volumes, while not changing the pedestal position or cell constant for each volume.

FIG. 9B shows geometries of microvolume liquid samples of different volumes positioned within a liquid analysis instrument.

FIG. 10 shows example sample image and reference volume images.

FIGS. 11A and 11B are example graphical user interfaces (GUIs) displayed while performing the initialization process.

FIG. 12 is an example GUI for displayed while performing the calibration process.

FIG. 13 is an example GUI for displayed while performing the measurement process.

FIG. 14 shows measured conductivities of different samples with various sample volumes.

FIG. 15 are images of pedestals with electrodes and optical fibers integrated within.

### DETAILED DESCRIPTION

Spectrophotometers designed to be used with fiber optics has made it possible to measure optical property of samples of microvolume, such as samples in the volume range of 0.25 microliters to 10 microliters. Such spectrophotometers use the surface tension of the liquid sample to confine the sample during optical analysis. Examples of the spectrophotometers are disclosed in U.S. Pat. Nos. 6,809,826B2 and 6,628,382B2, the entire contents of both are hereby incorporated by reference in their entirety.

These spectrophotometers are particularly useful in quantitation of biotechnology samples including nucleic acids or proteins where it is desirable to keep sample loss and/or cross-contamination to a minimum. For example, DNA samples produced either from synthesis or amplification typically exist in extremely small volumes. By measuring the absorbance of the DNA samples using the spectrophotometers, DNA concentration may be determined.

Electrochemical property measurement may further facilitate understanding sample composition. For example, the presence of high concentrations of ions such as salts in solutions of DNA can compromise the DNA's stability as well as introduce artifacts in downstream processes such as running gels. Excessive ions in the buffer can also compromise the integrity of DNA during storage. Ion concentration may be estimated based on the electrical conductivity of the sample.

The electrical conductivity of a liquid sample may be measured by contact measurements or inductive measurements. In both of these methods, the sensing elements (electrodes or inductive coils) need to be fully immersed in a solution to measure conductivity. Therefore, the size of the sensing element presents a lower limit on the volume of solution needed for measuring conductivity. There is a need to reduce the sample size requirement for measuring conductivity.

Embodiments described herein use the confinement of the sample by surface tension to measure one or more properties of the liquid sample. The liquid sample may have a volume of 0.25 microliters to 10 microliters. The properties may include physical properties, electrochemical properties, and optical properties. The physical properties may include sample volume. The electrochemical properties may include electrical conductivities and the pH level. The electrical conductivity (also referred herein as conductivity) is the ability of solutions to pass electrical current. The type of ions, the concentration of ions, and the temperature can all affect the conductivity of the liquid sample. The optical properties may include optical density, optical absorbance, and optical transmission.

In one example, the system for analyzing a sample includes a first surface including at least a part of a first electrode, a second surface including at least a part of a second electrode, and an electronic processing unit coupled to the first and second electrodes for receiving electrical signals from the sample held between the first surface and the second surfaces via surface tension.

The part of the first or second electrode may be part of or the entirety of the respective first and second surfaces. In other words, each first and second surface includes an electrically conductive part that is a portion of the respective first and second electrodes. During the measurement, the first and second surfaces are positioned opposite and facing each other, holding the sample in between. In one example, the first and second surfaces may be essentially flat and parallel to each other. In one example, the first and second surfaces are positioned horizontally. In another example, one or both surfaces may be curved.

In some examples, to regulate the geometry of sample placed between the surfaces, a hydrophobic coating or treatment is applied to one or both of the surfaces. This coating or treatment can be applied to help constrain the position of the drop solely to the surfaces themselves throughout the course of an experiment.

The relative position, such as the separation distance, between the first and the second surfaces are adjustable. In one example, at least one of the surfaces is coupled to an actuator. In another example, the first and second surfaces are part of the first and second anvils or pedestals. That is, the first and second surface may be the sample contacting surface of the corresponding pedestals. At least one of the pedestals is driven by an actuator. As such, different pedestal position corresponds to different separation distance between the two surfaces.

The electrochemical properties of the sample can be measured based on the received electrical signal. For pH (“potential of hydrogen”) measurements, one of the surfaces may be coated with metal oxide, such as zinc oxide (ZnO), and the other coated with silver chloride (AgCl). The electrical signal is an open circuit signal. For conductivity measurements, a second electrical signal, such as an AC signal, is applied across the sample via the electrodes while receiving the electrical signal.

In some examples, optical fibers may also be integrated with the first and second surfaces for performing optical measurement of the sample. As such, the electrochemical and optical properties of the same sample (e.g., same droplet) can be measured. In some examples, the electrochemical and optical properties of the same droplet can be measured simultaneously.

The system may include a camera for imaging the position of the surfaces and the sample. Imaging the position of the surface may include imaging the position of the pedestal (or the sample contacting surface of the pedestal). The camera may acquire pedestal image (images including at least one pedestal surface without sample) and/or sample image (images of the droplet positioned between surfaces). The actuator position (e.g., motor position) corresponding to a plurality of pedestal positions (e.g., measurement positions) may be updated/corrected based on the reference pedestal images. The volume of the sample may be determined based on the geometry of sample in the sample image. The actuator position and the sample volume may be determined by comparing the pedestal image and sample image with reference images in respective image library.

The first surface and the second surface (or the pedestals) are positioned at a measurement separation distance (or measurement position) while receiving the electrical signals for electrochemical property measurement. The measurement separation distance may be determined based on the sample volume. The sample volume may be a default volume, a volume specified via user input, or determined based on the sample image acquired by the camera.

Parameters for calculating the electrochemical property may be determined using a reference sample held with pedestals positioned at the measurement position. For example, for determining conductivity, the cell constant may be calculated based on the received current, applied AC signal, and known conductivity of the reference sample. The cell constant may be used for calculating the conductivity of a sample of interest.

The measurement of electrochemical properties in parallel with measurements of optical properties may provide additional information to researchers promoting success in downstream processes. The methods and systems described herein measure conductivity without the need for micro- or nano-fabricated devices and therefore can be easily and inexpensively applied to laboratories.

It should be understood that although embodiments are described herein as being used with a spectrophotometer or other optical instrument, embodiments may be constructed as stand-alone devices for measuring an electrochemical property of a microvolume liquid sample (i.e., without optical instrument components). Furthermore, although some embodiments are described herein with respect to measuring conductivity of a sample, the methods and systems described herein can be used to measure other electrochemical properties, such as, for example, a pH level, a resistance, or the like of the sample.

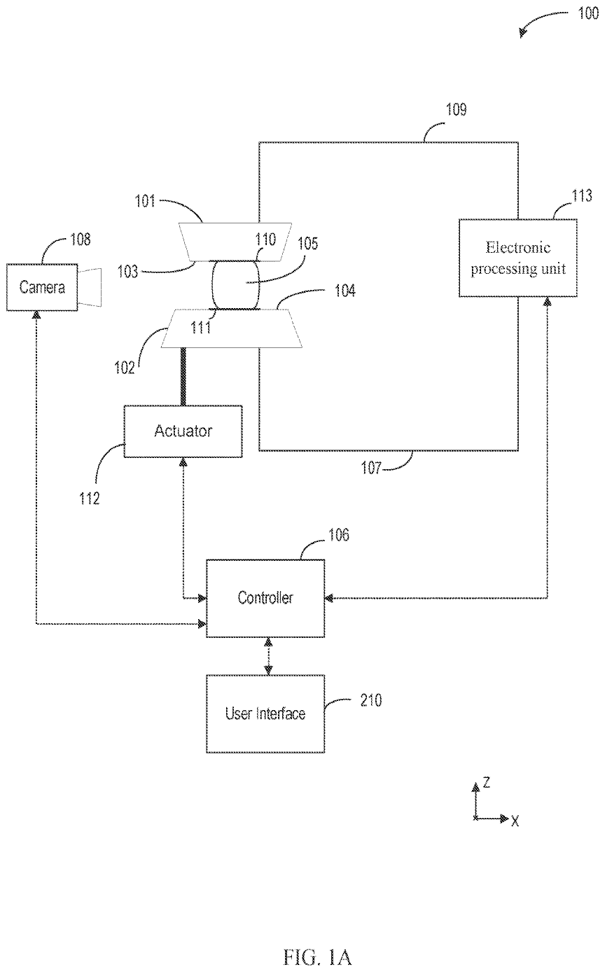

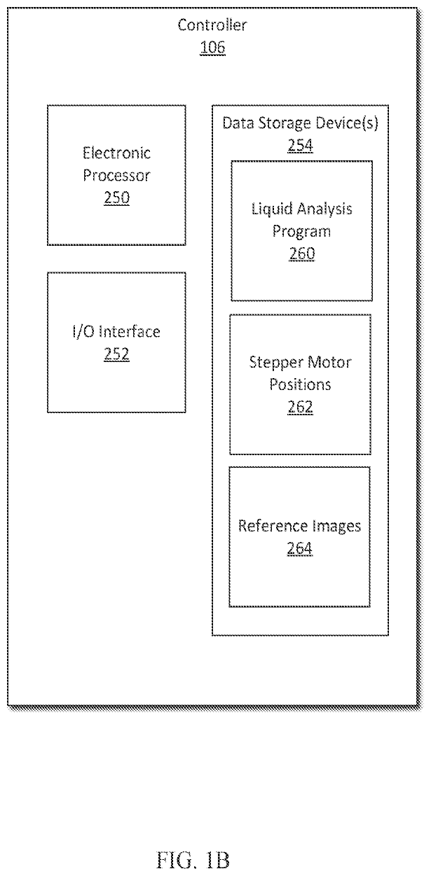

FIG. 1A illustrates a liquid analysis system 100. As illustrated in FIG. 1A, the liquid analysis system 100 includes pedestals 101 and 102, a first (e.g., an upper) surface 103, a second (e.g., lower) surface 104, a sample 105 of a microvolume liquid, a controller 106, electrical connections (e.g., wires) 107 and 109, a camera 108, an actuator 112 (e.g., one or more stepper motors and one or more associated lead screws), and an electronic processing unit 113. The system 100 may be used to measure one or more electrochemical properties of a micro-liquid sample 105 via one or more of the methods described herein. The system 100 may be positioned vertically so that the first and second surfaces are horizontal (in X-Y plane).

It should be understood that, in some embodiments, the components of the system 100 illustrated in FIG. 1A may be included in a common housing forming an instrument or device. However, in other embodiments, one or more components of the system 100 may be contained in separate housings or devices and may be coupled (e.g., communicatively, electrically, mechanically, or the like) as needed to carry out the methods described herein. Also, the system 100 may include additional components (e.g., multiple actuators 112, a user interface, such as a display, power components, and the like) and the functionality described herein as being performed by the components of the system 100 may be combined and distributed in various ways. For example, in some embodiments, the electronic processing unit 113 may be part of the controller 106, wherein the controller 106 is configured to perform the functionality of the electronic processing unit 113 as described herein. Furthermore, the functionality described herein as being performed by the controller 106 may be distributed among multiple controllers 106. The liquid analysis system 100 may also include additional components (such as power components), a user interface 210 (such as a display and/or user input device), a housing, and the like.

In addition, in some embodiments, although the first and second surfaces 103 and 104 are illustrated in FIG. 1A as being positioned horizontally (e.g., to establish an upper surface and a lower surface), it should be understood that other orientations are possible, such as, for example, a vertical orientation wherein the first and second surfaces 103 and 104 establish a left surface and a right surface. Accordingly, although embodiments may be described herein with respect to an upper and lower surface, embodiments described here can similarly be applied to systems including two surfaces in other orientations.

As illustrated in FIG. 1A, the sample 105 is loaded onto one of upper or lower surface 103 and 104, such as, for example, the lower surface 104 of pedestal 102, with a pipette. The sample 105, when emptied from the pipette and if the droplet has sufficient volume, will spread to cover the lower surface 104 until it encounters an edge of the upper or lower surface, such as, for example, an edge of the upper surface 103. The liquid sample 105 is contained by surface tension between the upper surface 103 of the pedestal 101 and the lower surface 104 of the pedestal 102. In some embodiments, 2 microliters of a water-based solution can effectively cover an area of one or both of the surfaces 103 and 104 having approximately a 2-millimeter diameter. Alternatively, the spread of the sample 105 can be limited by a change in the surface tension characteristic. For example, in some embodiments, a polymer surface of a material can be used to limit the spread of the solution.

Via the one or more actuator(s) 112 (such as, for example, one or more stepper motors), the pedestal 102 is brought into a measurement position and, optionally, then into close proximity to the pedestal 101, making contact with the deposited sample 105 and wetting the entire confining surface before returning to a sample measurement position. Actuator 112 herein is shown mechanically coupled to the lower pedestal 102 for adjusting the lower surface 104. In some examples, the actuator may instead be coupled to the upper pedestal 101. In some examples, each of the pedestals may be coupled with an actuator.

In some embodiments, the upper and lower surfaces 103 and 104 have roughly identical areas. Alternatively, the upper and lower surfaces 103 and 104 may have different areas. For example, in some embodiments, the lower surface 104 is larger than the upper surface 103 to provide a larger loading target. When two different sizes of surfaces are used and when the smaller surface is brought into sample compression position, the sample 105 may be pulled into the gap between the pedestals by capillary action. In this configuration, the diameter of the smaller surface may center the sample between the upper surface 103 and the lower surface 104.

In some embodiments, the upper and lower surfaces 103 and 104 are flat surfaces positioned horizontally for holding the sample 105. In other embodiments, one or both more of the upper and lower surfaces 103 and 104 may have a curved surface. Using a curved surface may assist in positioning the sample 105 between the surfaces 103 and 104, and, in some embodiments, may assist in creating a consistent shape of the sample 105.

To measure an electrochemical property of the liquid sample (e.g., conductivity), the upper and lower surfaces 103 and 104 can be used as a two-pole conductivity meter. In particular, each of the upper surface 103 and the lower surface 104 may include at least a portion 110 and 111 that is electrically conductive. In some examples, the entire surface 103, the entire second surface 104, or both may be electrically conductive. The conductive portions 110 and 111 act as electrodes for passing and receiving electrical signals to and from the sample 105 that is in direct contact with the conductive portions 110 and 111. Herein, portions 110 and 111 are also referred to as electrodes 110 and 111. The conductive portions may be metal surfaces with a diameter between 1 millimeter and 3 millimeters, such as, for example, 2.5 millimeters. One or both of the conductive portions 110 and 111 may be hydrophobic. For example, in some embodiments, one or both of the portions 110 and 111 may be coated with a hydrophobic substance coating or a laser treatment may be applied to the surface to make it hydrophobic. In some examples, a portion (110 and 111) of each of the surfaces 103 and 104 is electrically coupled to the electronic processing unit 113 via connections 109 and 107.

The separation distance between the two surfaces 103 and 104 (and, hence, the two electrodes 110 and 111) can be controlled by moving, vertically, the position of one or more of the surfaces (for example, via moving one or more of the pedestals). For example, the bottom pedestal (i.e., lower surface 104) is moved via operating the actuator 112.

The electronic processing unit 113 is configured to measure electrical signals via one or both of the electrodes 110 and 111 and, in some embodiments, is also configured to apply an oscillating (AC) voltage the sample 105 via one or more both of the electrodes 110 and 111. For example, in some embodiments, the electronic processing unit 113 includes an electrical signal generator. The electronic processing unit 113 may include a circuit board for reading measured electrical signals (e.g., AC voltages) from the electrodes 110 and 111 (and optionally applying electrical signals via the electrodes 110 and 111) and software or firmware associated with the board may be configured to translate voltages directly into electrochemical parameters (e.g., conductivity values) that can be communicated to other components of the system 100. In other embodiments, rather than translating voltage directly into electrochemical parameters, the electronic processing unit 113 may process voltages into one or more intermediary or filtered value, which may be communicated to the controller 106 for further processing, including, for example, determination of an electrochemical property of the sample 105. In some embodiments, the electronic processing unit 113 may include an electronic processor (e.g., a microprocessor), which may instruct the signal generator, process measured electrical signals, or a combination thereof. For example, to measure the conductivity of the sample, electrical signals may be measured by one or both of the electrodes 110 and 111 while an oscillating (AC) voltage is applied to the sample positioned between the two flat metal surfaces via one or more of the electrodes 110 and 111. As noted above, it should be understood that other electrochemical properties of the sample may be measured using the liquid analysis system 100. For example, as an alternative to or in addition to measuring conductivity, the pH level of the sample may be measured based on the received electrical signals without applying electrical signals to the sample (e.g., by measuring electrical signals of the sample in an open circuit configuration).

The camera 108 is positioned to capture one or more images of the pedestals 101 and 102, such as, for example, at least a portion of the upper surface 103 and the lower surface 104 and the separation between these surfaces 103 and 104, including any sample positioned between the surfaces 103 and 104. As described in more detail below, images captured via the camera 108 may be used to identify actuator positions (or stepper motor positions) for one or more separation distances, a volume of a sample positioned between the surfaces 102 and 103, or a combination thereof. In some examples, the liquid analysis system 100 may include a light source for illuminating the sample 105 while capturing the images by camera 108.

As described above, the actuator 112 is configured to move at least one of the upper surface 103 and the lower surface 104 (i.e., at least one of the pedestals 101 and 102). As also noted above, in some embodiments, the system 100 includes multiple actuators 112. In some embodiments, the actuator 112 may include one or more stepper motors.

The controller 106 is configured to communicate with the electronic processing unit 113 to receive measured electrical signals and, in some embodiments, to send commands to the electronic processor unit for applying electrical signals via the electrodes 110 and 111. The controller 106 is configured to communicate with the camera 108 to send commands to the camera 108 to capture images and receive the captured images. As also illustrated in FIG. 1A, the controller 106 is further configured to communicate with the actuator 112 to send commands to the actuator 112 and receive position information from the actuator 112 (e.g., a number of motor steps). The controller 106 may communicate with the electronic processing unit 113, the camera 108, and the actuator 112 via a wired connection, wireless connection, or a combination thereof.

As illustrated in FIG. 1B, the controller 106 may include an electronic processor 250, an input/output (I/O) interface 252, and a data storge device 254; however, it should be understood that the controller 106 may have additional or fewer components. as suitable for the application and setting, such as, for example, multiple electronic processors, multiple I/O interfaces, multiple data storage devices, or a combination thereof. In some embodiments, some or all of the components included in controller 106 may be attached to one or more motherboards and enclosed in a housing (e.g., including plastic, metal, and/or other materials). In some embodiments, some of these components may be fabricated onto a single system-on-a-chip (SoC0 (e.g., an SoC may include one or more processing devices and one or more storage devices).

As used herein, “processor” or “electronic processor” refers to any device or portion of a device that processes electronic data from registers and/or memory to transform that electronic data into other electronic data that may be stored in registers and/or memory.

The data storage device 254 may include one or more memory devices such as random-access memory (RAM) devices, hard drive-based memory devices, solid-state memory devices, networked drives, cloud drives, or any other memory devices. In some embodiments, the data storage device 254 may include non-transitory computer readable media having instructions thereon that, when executed by one or more processors (e.g., the processor 250), causes the controller 106 to perform any appropriate ones or portions of the methods disclosed herein. For example, one or more data storage devices 254 included in the controller 106 may store various applications and data for perform one or more of the methods described herein or portions described herein. For example, the one or more data storage devices 254 may store a liquid analysis program 260, stepper motor positions 262 used to position the pedestals 101 and 102 at a plurality of different separation distances, reference images 264 used by one or more of the described methods, or a combination thereof. It should be understood that each method described herein may be implemented via one application or multiple applications.

The I/O interface 252 of the controller 106 may include one or more communication chips, connectors, and/or other hardware and software to govern communications between the controller 106 and other components such as the user interface equipment 210.

In some embodiments, the liquid analysis system 100 provides a stand-alone or dedicated instrument or device (or set of instruments or devices) configured to measure an electrochemical property of a liquid sample. However, in other embodiments, the liquid analysis system may be configured to perform additional measurements or analysis of a liquid sample, including, for example, additional measurements or analysis of sample's physical properties and/or optical properties. Combining such measurements or analysis in one system (e.g., one instrument) creates efficiencies and more accurate analysis as multiple measurements can be taken on the same sample without having to change the position of the sample, move the sample to a different instrument, or use a separate sample of the same solution in a different instrument, all of which can introduces delays and potentials for contamination or unintended variances between measurements.

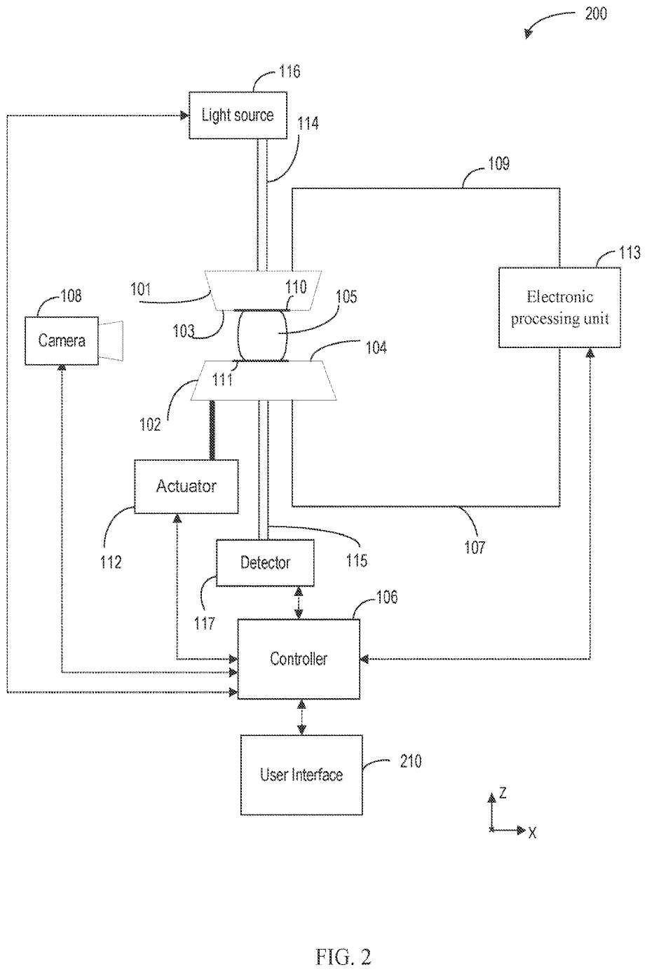

FIG. 2 illustrates another liquid analysis system 200. System 200 may measure both electrochemical and optical properties of the same sample positioned between the surfaces. In some examples, measurements of the electrochemical and optical properties can be conducted simultaneously. As illustrated in FIG. 2, the liquid analysis device 200 includes similar components as the liquid analysis system 100, as described above. In particular, the system 200 includes the pedestals 101 and 102 and the upper and lower surfaces 103 and 104 for holding the sample 105 via surface tension, the controller 106, the one or more electrical connections (e.g., wires) 107 and 109, the camera 108, the first electrode 110 and the second electrode 111, the actuator 112 (e.g., one or more stepper motors), and the electronic processing unit 113. Accordingly, with these components, the system 100 is configured to perform the electrochemical measurements and analysis described herein.

However, as illustrated in FIG. 2, the liquid analysis system 200 also includes a first optical fiber 114 connected to a light source 116, and a second optical fiber 115 connected to a detector 117. The optical fiber may have endings be a part of the surface. One fiber is the source, and the other fiber is the receiver. The optical fibers may be mounted coaxially with and perpendicular to the parallel surfaces. For example, in this configuration, the liquid analysis system 200 may include a detector. The detector may include a spectrograph for splitting the light based on its wavelengths. Such an instrument is configured to quantitatively measure the reflection or other optical transmission property of a sample, which may be used to determine the amount of a particular compound in a sample.

For some applications, the optical fibers can be replaced by miniature sources like light emitting diodes (LEDs). Small solid-state detectors with associated filters like those used in color charge coupled devices (CCDs) for imaging may replace the receiving fiber and detector.

Combining the electrochemical measurement and analysis described herein with the optical-based measurements provided such an optical instrument allows different types of measurements to be performed on the same sample positioned within the instrument, which, as noted above, introduces efficiencies and improved data collection and associated processing.

It should be understood that the electrochemical measurement methods described herein can be performed via various types of optical measurement instruments for detecting an optical property of the liquid sample positioned between the first surface 103 and the second surface 104 and is not limited to the example system illustrated in FIG. 2 or example types or brands of such instruments described herein. For example, as noted above, in some embodiments, the optical fibers can be replaced by miniature sources like LEDs and detectors (e.g., solid-state detectors) with optical filters. Also, as noted above, in some embodiments, the optical measurement device may have different surface orientations for holding the sample 105, including, for example, a vertical orientation. It should also be understood that, in some embodiments, the detection of an optical property of the sample 105 positioned between the surfaces 103 and 104 can occur simultaneously with at least some portions of the electrochemical measurement methods described herein, which can provide further efficiencies in sample analysis.

With respect to the example liquid analysis system 200 in FIG. 2, light from the light source 116 may travel through the first optical fiber 114 positioned in the upper pedestal 101 where the light radiates downward through the sample 105 and is collected by the second optical fiber 115, which may act as a light pipe. It should be understood light can be transmitted in either direction through the sample 105 and is not limited to being transmitted from the first optical fiber 114 downward through the sample 105. The detector 117 receives the collected light. A concentration of a particular component in the sample 105 may be determined based on the collected light.

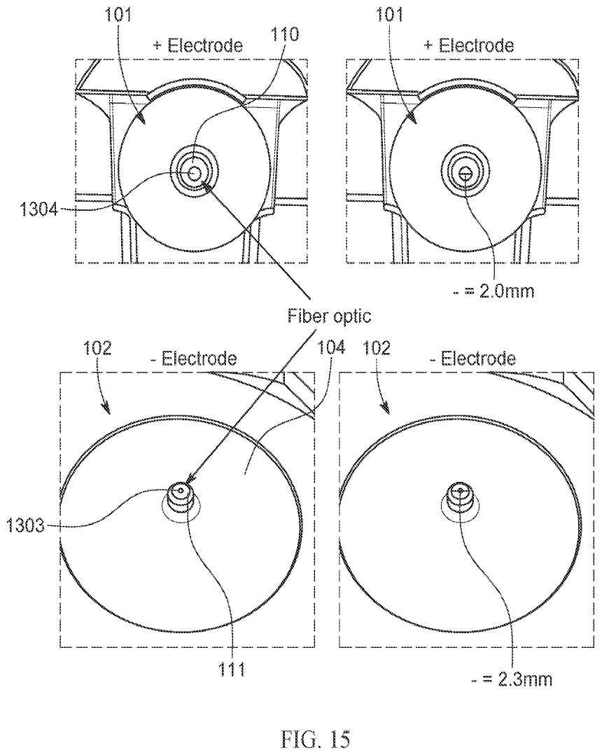

Example upper and lower surfaces with optical fiber integrated within are shown in FIG. 15. FIG. 15 are photos of positive and negative electrodes 110 and 111 of the pedestals 101 and 102. The optical fibers 114 and 115 terminate at the electrodes 110 and 111, respectively. As such, one end of the optical fiber (1304 or 1303) and the respective electrodes form at least a part of the respective first and second surfaces. In FIG. 15, electrodes 110 and 111 include a hole at the center for receiving the end of the optical fiber. As illustrated in FIG. 15, the positive electrode has a radius of about 2.0 millimeter and the negative electrode has a radius of about 2.3 millimeter. The positive electrode can be positioned slightly off-center of the negative electrode to maintain surface tension and allow the micro-liquid droplet to form a bubble.

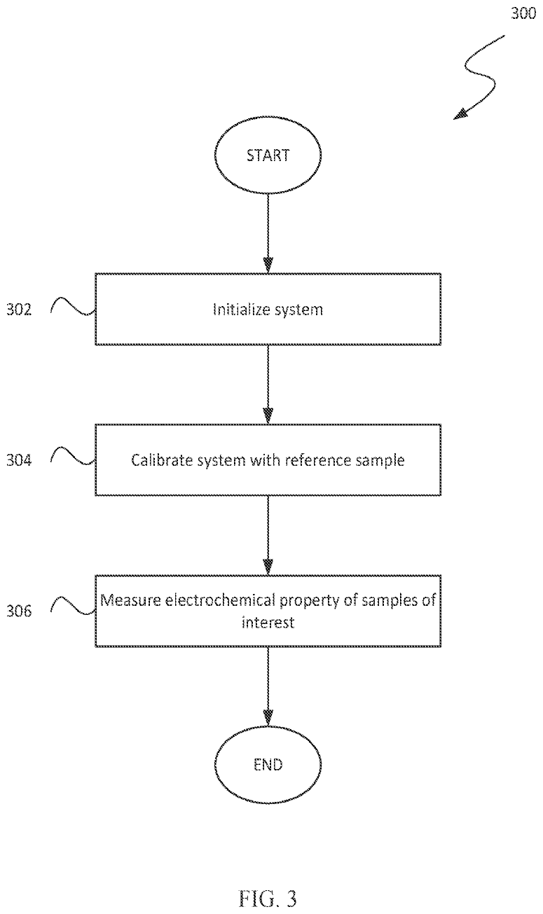

FIG. 3 is a flowchart illustrating a method 300 for measuring the electrochemical properties for a micro-liquid sample of interest. Method 300 may be implemented using the liquid analysis system 100 or the liquid analysis system 200 described above. The method 300 is described herein as being performed via the controller 106. However, it should be understood that the method 300 may be performed by multiple software or hardware components in various combinations and configurations.

At 302, the system is initialized. Initializing the system may include one or more of initializing the positions of the pedestals and the imaging parameters. Images of one or both of the pedestals (or the surfaces) are acquired by the camera (such as camera 108 of system 100 and 200), and the system is initialized by analyzing the images. The images including one or more surfaces/pedestals without sample (i.e., empty pedestal), which are used for initializing the pedestal position, are herein referred as pedestal images.

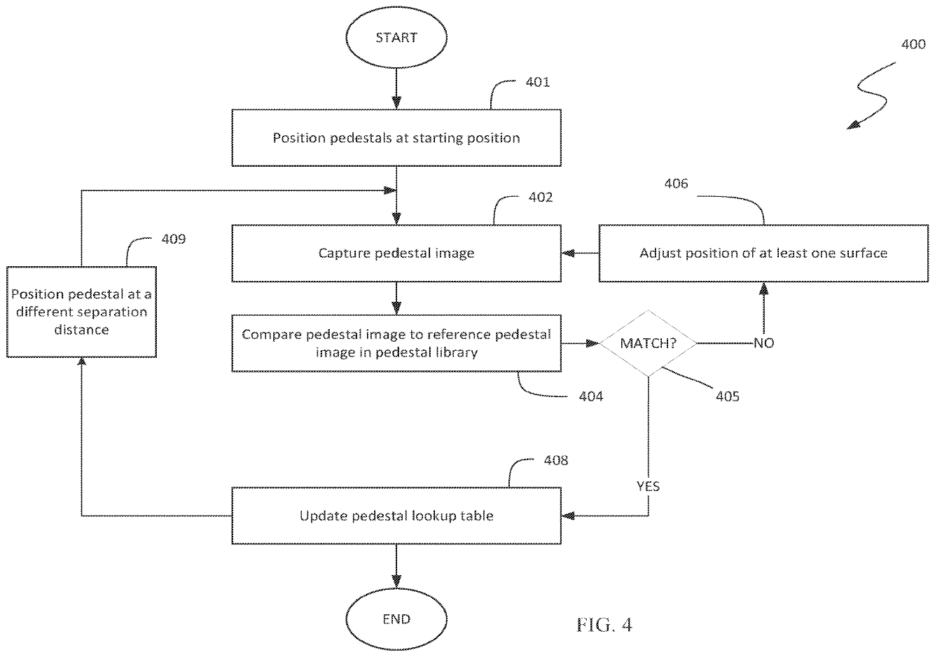

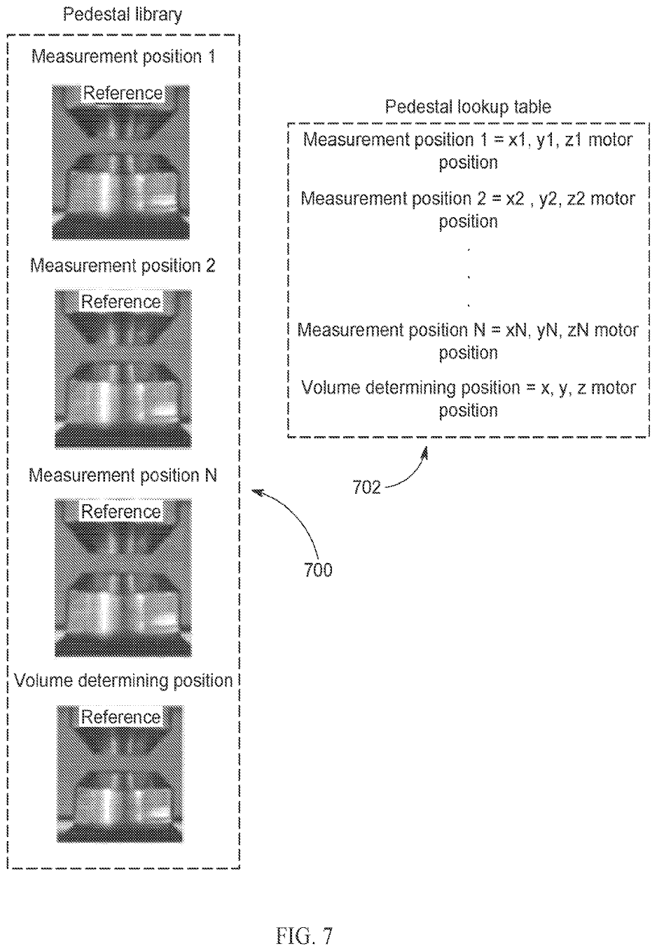

Initializing the position of the pedestals may include determining the actual positions of the first and second surfaces (or the pedestal). The actual position of the pedestals can be determined by comparing pedestal images with a pedestal library (700 of FIG. 7). The pedestal library contains reference pedestal images of the empty pedestals at known separation distances. The details procedures for initializing pedestal position are presented in method 400 of FIG. 4.

The pedestal positions may be slightly different among equipment and may change overtime. By determining the actual positions of the pedestal positions, a correspondence (such as in the form of a pedestal lookup table 702 of FIG. 7) between the actual position of one or more pedestals and the actuator parameter (such as the motor stepper position) is established. The pedestal positions may be initialized based on the correspondence. After initializing the pedestals, the surfaces may be accurately positioned to achieve the desired separation distance by operating the actuators. For example, the pedestal initialization process may establish motor stepper positions for the volume determination distances (at the volume determining position) as well as one or more measurement distances (at the measurement positions), wherein each measurement separation distance is associated with a particular sample volume. During the calibration process 304, the pedestals are positioned at a volume determination distance, and, during the measurement process 306, the pedestals are positioned a particular separation distance (at the selected measurement position) associated with the volume determined during the calibration process 304.

In some examples, initializing the pedestal position may optionally include correcting the camera position relative to at least one of the pedestals (or the electrodes of the pedestals). In practice, variations in manufacturing may produce differences in the relative position of the pedestal and the camera from instrument-to-instrument. As a result, the position of the pedestal in the reference images from the libraries and in an acquired image can be substantially different. The camera position may be determined by comparing the pedestal image with the reference image, such as a reference pedestal image in the pedestal library. For example, shift of the pedestal position in the pedestal image from the reference image can be quantified and corrected via image registration. The shift may be applied to either the acquired image by the camera or the reference images in method 400 to correct the camera position difference in instrument.

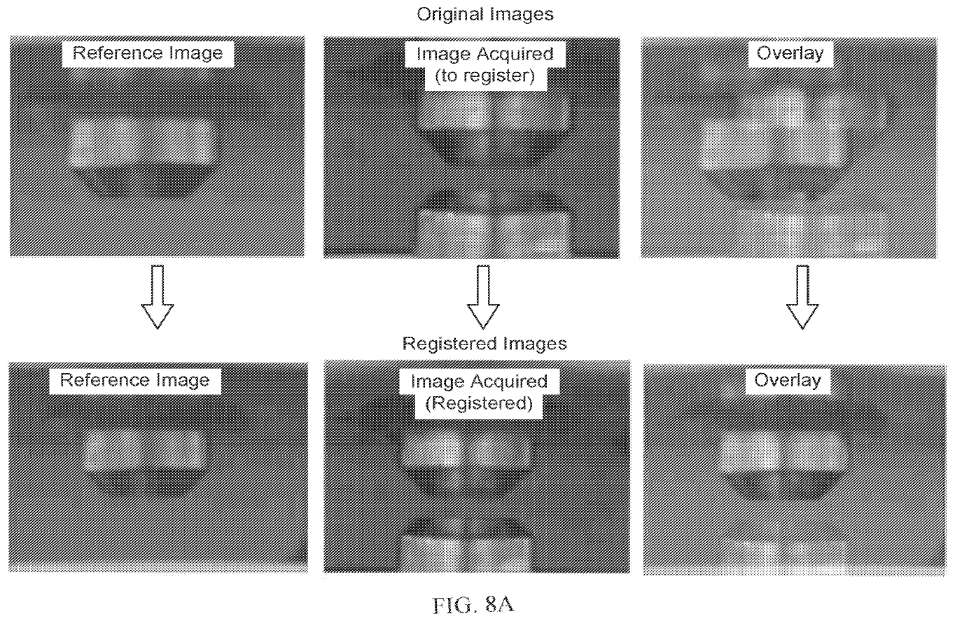

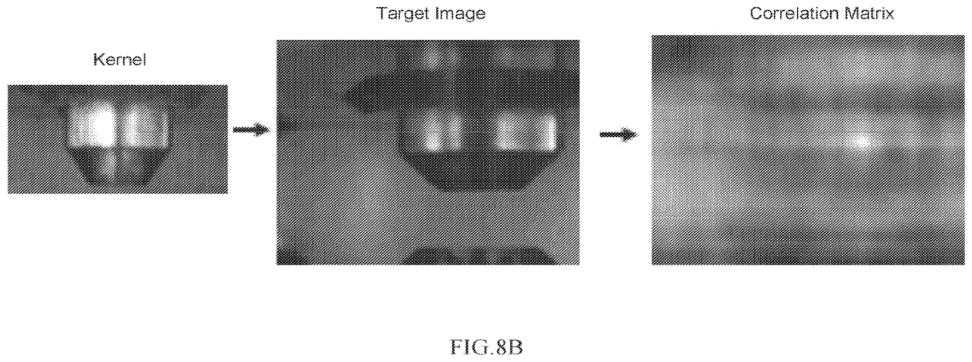

FIG. 8A-8B illustrate an example of correcting camera position via image registration. FIG. 8A, the top panel shows the differences in the location of the top pedestal in a reference pedestal image (left) and the acquired pedestal image (middle). The overlay image (right) shows shift of the pedestal between the reference pedestal image and the pedestal image. In the bottom panel, the acquired image was registered (shifted) so that the top pedestal in the pedestal image overlaps accurately on the top pedestal in the reference pedestal image.

In some embodiments, the workflow described herein contains both an automated and backup manual image registration step to account for differences in the relative position of the camera and top pedestal of the instrument. The output produced by this image registration step are two parameters referred to as “dx” and “dy,” which indicate the magnitude of shift necessary to align the reference and acquired images in x and y. Given the design of the instrument, adding a rotation dimension to the image registration may not be necessary.

In some embodiments, the automated image registration step is carried out by calculating a correlation matrix using the structural similarity parameter. FIG. 8B illustrates that the image registration method can be based on composing a correlation matrix by sampling the kernel image over a larger target image. In this case, the kernel is a cropped image of the top pedestal. When this cropped image of the top pedestal sampled over a larger image containing the top pedestal, the dx and dy parameters can be calculated from the peak present in the correlation matrix (see, e.g., white dot in the correlation matrix in FIG. 8B). In addition to the peak position, the locations of the cropping boxes used to produce the kernel and target image as well as the position of the peak in the correlation matrix produced when applying this analysis to the reference image (from library) can be used to compute values for dx and dy.

In some examples, the initialization of the pedestal positions may be skipped, and a pre-determined pedestal lookup table including pedestal positions (e.g., defined in terms of motor positions) for various sample volumes may be used, according to processes 304 and 306.

Initializing the system at 302 may optionally include initializing camera parameters for imaging the pedestal and/or the sample by comparing the acquired pedestal image with the reference pedestal image in the pedestal library. The camera parameters may be adjusted so that the acquired pedestal image has similar lighting conditions as the reference pedestal image. For example, the exposure time of the camera may be adjusted by comparing the acquired pedestal image with the reference.

The image based initializing pedestal positions (in 302) and estimating sample volume (in 304) rely on having enough light in the room so that features in the acquired images can be clearly resolved. The ambient light or a light source for the camera may be estimated and adjusted to achieve the room brightness required for the electrochemical property analysis. For example, the brightness of the room or a light source may be calculated by comparing the pedestal image with reference images acquired under different lighting conditions. These comparisons may be carried out using a global calculation of structural similarity. The reference image taken at a room brightness that is the closest to that of the acquired image will correspond to the highest calculated structural similarity, and, thus, reveals the room brightness. In response to the room brightness being insufficient, a popup or other type of warning message or alert can be output advising the user to increase the room's light level before proceeding. In another example, a light source may be manually or automatically adjusted to satisfy the required room brightness.

In some examples, throughout the course of experiments, the room brightness can be estimated prior to analyzing any images taken by camera 108. For example, the room brightness can be found by comparing the droplet's image to reference images of a droplet of the same volume collected at different light levels using the structural similarity metric. The verification of the room's brightness can ensure that imaging and image analysis steps can be carried out to produce accurate measurement of conductivity. In some embodiments, in addition to using image processing to determine brightness or as an alternative, an ambient light sensor or similar device may also be used to measure a brightness level of the room. In some embodiments, a minimum level of room light required for image-based detection of a droplet is at 27 microwatts at 500 nanometer of room light, which achieves greater than approximately 90% accuracy for detecting volumes of 1 microliter and 2 microliters. Accuracy may decrease as the room is dimmer.

In the calibration process 304, a reference sample (also referred to herein as a calibration droplet) is used for estimating the sample volume. In some examples, parameters for determining the electrochemical properties are also determined using the reference sample.

When measuring conductivity of a liquid sample, the conductivity can be calculated based on the sample's electrical resistivity (or resistance) measured in response to the applied voltage, as well as a cell constant C. The cell constant depends on the geometry of the electrodes (area (A) and separation distance (D)). By measuring the sample's resistance, the conductivity K is calculated according to Equation (1) below.

$$K = ( \frac{1}{R} ) C = ( \frac{1}{R} ) ( \frac{D}{A} ) \qquad Equation 1$$

The above equation assumes that electrodes will be fully immersed into a solution. In the configuration with sample confined between surfaces via surface tension (such as shown in FIG. 1A and FIG. 2), the geometry of the droplet affects the resistance measurement. This is because the path that electric charge takes between the first and second electrodes changes with the geometry of the droplet. For example, when using extremely small separations of the pedestal, the droplet can come into contact with other conductive parts beyond the electrodes (such as the aluminum housing used to mount the electrodes), disrupting the electric field and corrupting measurements of conductivity. Fringing effects can take place where the electric field can move between electrodes without passing through the solution. As a result, a small change in the droplet geometry can result in different conductivity measurement even when the same sample is analyzed.

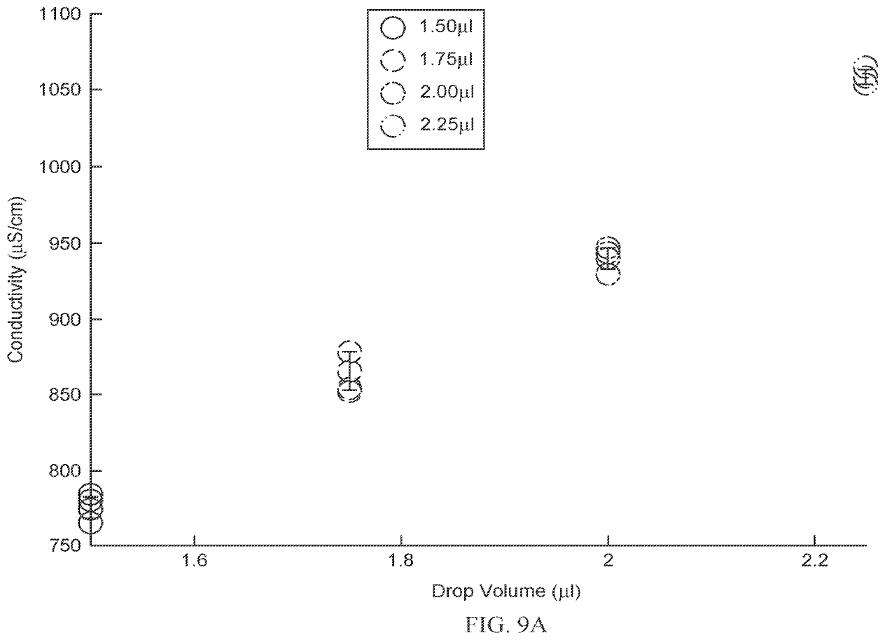

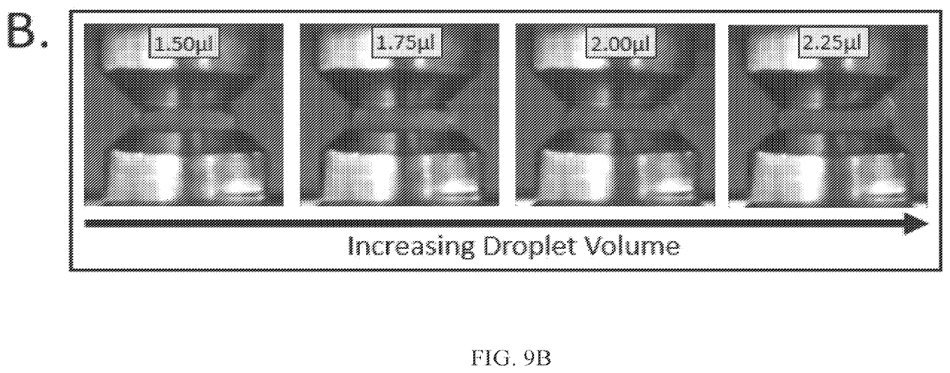

The sensitivity of the conductivity measurements to droplet volume is shown in FIG. 9A. In this example, the pedestal separation and the cell constant were calibrated using 1.5 microliters of salt solution. As shown in FIG. 9A, the measured conductivity of the salt solution linearly increases as function of the droplet's volume even though the separation of pedestals and all other instrument parameters remained constant. FIG. 9B shows images of droplets from which the conductivities were measured. The pedestal positions are the same in each of the images of FIG. 9B. As the volume increases, the shape or geometry of the droplet changes. As the droplet volume increases, the droplet geometry expands and begins attaching to the upper portions of the pedestal. At a volume around 2 microliters, the droplet begins to asymmetrically bulge and contacts parts beyond the surfaces for holding the sample.

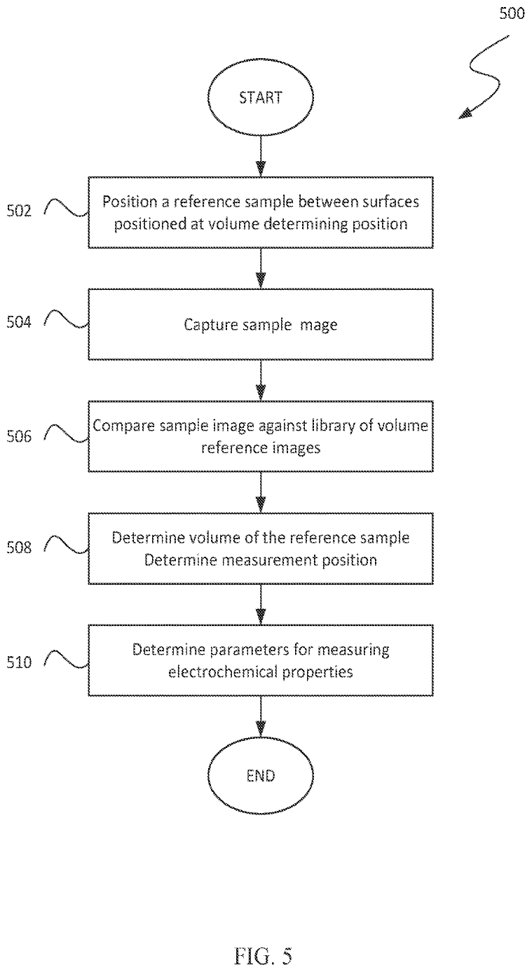

In order to address the effect of droplet volume on conductivity measurement, the volume of the reference sample for calibration process is the same as the volume of the sample of interest in the measurement process. To achieve this, the same pipette with the same settings is used for loading sample in both the calibration and measurement processes. In order to better control the geometry of the sample, the sample volume delivered by the pipette may be estimated, and a measurement position (or measurement separation distance) corresponding to the estimated sample volume is selected. The selected measurement position corresponds to the optimal pedestal separation distance for measuring the electrochemical property of the sample. When measuring the conductivity of the sample droplet, the cell constant may also be determined based on the known conductivity of the reference sample. The details of the calibration process are presented in method 500 of FIG. 5.

In some examples, the sample volume calibration step may be skipped, and the sample volume may be determined based on user input. For conductivity measurements, a pre-determined cell constant may also be used in process 306 (e.g., rather than being determined as part of the calibration process 304). The details of the calibration process 304 are presented in method 500 of FIG. 5. By estimating the delivered sample volume, the sample of interest can be positioned with an optimal geometry for electrochemical property measurement at 306.

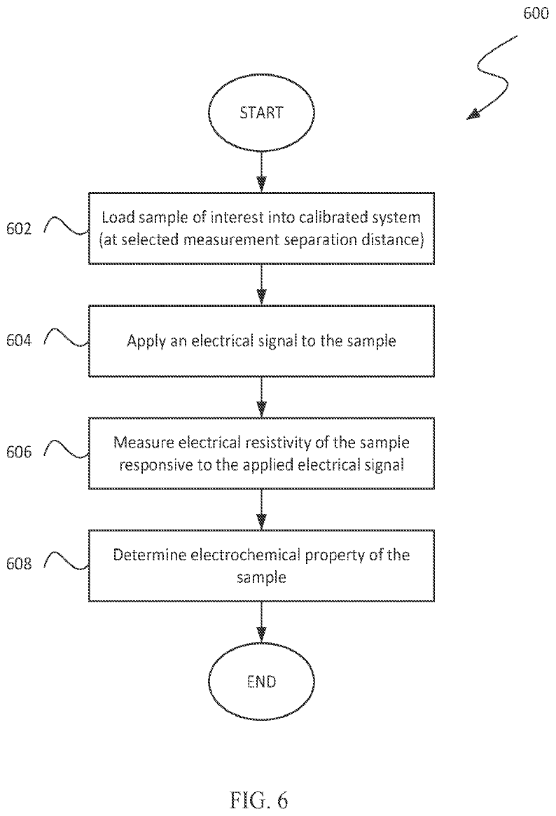

At 306, the electrochemical properties of one or more samples are analyzed. The sample of interest may be measured based on the electrical signals received from electrodes coupled to the sample. The volume of the sample of micro-liquid of interest is the same as the reference sample used in the calibration process of 304. For example, the same pipette with the same pipette setting may be used for loading both the reference sample and the sample of interest on the liquid analysis device. The sample of interest is measured by positioning the pedestal at the selected measurement position determined at 304. The details for measuring the electrochemical properties of the sample of interest are presented in method 600 of FIG. 6.

The electrochemical properties may include electrical conductivity. In some examples, an electrical signal, such as an AC signal is applied across the sample via the electrodes, while measuring the current via the same electrodes. The resistivity may be determined based on the applied signal and the current. The conductivity may then be calculated based on the resistivity and the cell constant from 304.

Additionally or alternatively, the electrochemical properties may include pH level of a sample solution, wherein the pH level is a quantitative measure of the acidity or basicity of the solution. In some examples, at 306, after loading the sample of interest and set the pedestals at the measurement distance, a pH level of the sample can be measured based on an electrical signal received from the sample. As an open circuit is used to measure a pH level, in this embodiment, no electrical signal generator may be used or incorporated into the liquid analysis system or device 100 or 200. For example, in some embodiments, one or both of the pedestals may be coated to provide for pH level measurements (or more accurate pH measurements). As one non-limiting example, one of the pedestals may be metal oxide and the other pedestal may be coated with silver chloride (AgCl) ink and a controller (e.g., the controller 106 as described above) can detect the open circuit voltage, which can be used to measure the pH of the droplet. It should be understood that various coatings may be used with pH measurements and the listed coatings are provided as one example. For example, other insoluble compounds with high electron mobility, wide band gap, or both may be used to coat one or both of the pedestals.

FIG. 4 is a flowchart illustrating the initializing pedestal positions, which is part of the system initializing process of 302 in FIG. 3. The pedestal positions of the liquid analysis system (such as the liquid analysis system 100 or system 200) are initialized or determined, in terms of motor steps, for various separation distances. For example, the pedestal positions are initialized by comparing acquired pedestal images (i.e., pedestals without sample in between) and reference pedestal images in a pedestal library. In each reference pedestal image, the pedestals are positioned at different measurement positions (i.e., with surfaces separated at different pre-defined separation distances). The pre-defined separation distances may include the calibration separation distances (used as part of the calibration process 304) as well as one or more measurement separation distances (used as part of the measurement process 306), wherein each measurement separation distance is associated with a sample volume. As a result of the initialization, the motor positions corresponding to the pedestal measurement positions (or pedestal positions in the reference pedestal images) are defined and stored. The motor may be a stepper motor and the motor positions may be represented as the number of steps.

FIG. 7 illustrates an example pedestal library 700 and a pedestal lookup table 702. The pedestal library includes reference pedestal images at different measurement positions with different separation distances. One or more of the measurement positions may be dedicated as volume determining positions that used for determining the volume of the sample at 304 of FIG. 3. The pedestal lookup table include the motor position corresponds to each of the measurement positions in the pedestal library. Each motor position may be defined as positions in one or more axes. Pedestal lookup table 702 shows a motor position along x, y and z axes that correspond to each measurement position. The motor positions in the pedestal lookup table are updated in method 400.

At block 401, the controller 106 (via the actuator 112) sets the pedestals at a starting position (e.g., representing a starting position of the actuator in terms of motor positions). In some embodiments, the starting position is a default position (defined in terms of motor positions) and may represent a maximum or minimum position of the pedestals (which may be established during initial power-up of the system or device). In other embodiments, the starting position is the motor position corresponding to a measurement position.

At block 402, the camera 108 captures one or more pedestal images of the empty pedestals. In some examples, the image includes the at least a portion of the electrodes or a portion of the surfaces of the pedestals. In other examples, the pedestal image may include only one of the upper of lower electrodes. For example, only the electrode associated with the pedestal coupled with the actuator 112 may be imaged.

At block 404, the controller 106 receives the captured pedestal image and accesses the pedestal library to retrieve one or more of the reference pedestal images (for a predetermined separation distance). Each of the reference pedestal image is associated with a measurement position. Each measurement position corresponds to a motor position. The reference pedestal image corresponds to the current measurement position or starting position (set at 401 or 409) is loaded. The controller 106 compares the pedestal image from 402 against the loaded reference pedestal image using an appropriate image comparison/registration technique. Comparing the pedestal image and the reference pedestal image include compare the entire images or a portion of the images. In some examples, pedestal in the images may be segmented and compared.

Various image processing methods may be used for matching two images. For example, the structural similarity index compares images by extracting the underlying structure using local changes in luminescence and contrast. This index was developed and typically used to assess image degradation. As such, the structural similarity index most commonly compares two images of the same object and outputs a metric that indicates how degraded one image is relative to another.

In some examples, the structural similarity index can be used throughout the image analysis described herein as both a single global parameter describing the similarity of two images as well as a way to create correlation matrices. A correlation matrix indicates whether or not the image of a small object, referred to as a kernel, is located within a larger image. To create a correlation matrix, the kernel image is continually sampled at every point within the larger image. At every point, a structural similarity calculation is performed comparing the kernel to a cropped section of the larger image equal in size to the size of the kernel. The value of the structural similarity calculation at that position then becomes the value of the correlation matrix at that position. Therefore, every position within the correlation matrix indicates how similar the original image is to the small kernel (if the small kernel was positioned there). Large amplitude peaks present in correlation matrices correspond to the location where the small kernel image is present in the large image.

Besides the structural similarity algorithm, other techniques, including other variants of the spatial correlation, Pearson Correlation, and Cross Correlation methods can be used for finding similarity in images. Sobel and Canny filters could also be used to automatically detect and locate the size of objects in images by locating edges of structures. A Sobel filter locates the edges of features by spatially mapping gradients in intensity throughout the image. The location and size of extended areas where there are sharp changes in intensity denote the likely position of an edge of an object. The positions and sizes of edges in the image can reveal the size of objects. As Sobel filter rely on even illumination of objects, extra lighting (on the instrument or separate from the instrument) may be used when employing such a filter. Correction algorithms can also be used to homogenize the background of images collected when objects are unevenly illuminated. Other computer vision and machine learning technique could also be used to identify and characterize objects in images.

In one example, a cross-correlation or a Pearson correlation could be used. A cropped image of the pedestal containing both the upper and lower pedestal may be used in this analysis. When applying these types of similarity metrics, cropping a section of the image that is equally split between elements that remain fixed and elements that change can maximize the change in similarity metric per change taking place in the image. In some embodiments, the cropped images may contain roughly even contributions from the upper and lower pedestals. In some configurations of the instrument, changing the separation of the upper and lower pedestal involves vertical movement of the lower pedestal only and the top pedestal does not move during experiments or throughout the life of the instrument. However, instruments with other configurations can be used with the systems and methods described herein.

In response to determining a match between the pedestal image and the reference pedestal image at 405, the controller 106 updates the pedestal lookup table at 408. Updating the pedestal lookup table includes updating and storing the current motor position associated with the measurement position set at 401 or 409. That is, the motor position associated with a predefined separation distance is updated.

In response to there not being a match at 405, the controller 106 communicates with the actuator 112 to adjust the position of at least one surface at 406. In various embodiments, the controller 106 repeats this image acquisition and comparison process until the captured pedestal image matches the loaded reference image.

After updating the pedestal lookup table at 408, the controller 106 may adjust the actuator to position the surfaces at a different separation distance (e.g., at a different measurement position in the pedestal library) to update the motor position of another measurement position in the pedestal lookup table. Method 400 may exit when motor positions of all measurement positions in the pedestal lookup table are updated.

The updated pedestal lookup table 702 is used in the calibration and sample measurement process (304 and 306 of FIG. 3) to position the pedestals at certain separation distance. As noted above, in some embodiments, a predefined lookup table may be used, which may eliminate the need to create or update the lookup table as described in method 400.

FIG. 5 is a flowchart of method 500 detailing the calibration process 304 of FIG. 3. In the calibration process, sample volume of a reference sample with a known electrochemical property is estimated based on droplet images. A measurement position corresponding to the sample volume is selected. Further, parameters, such as the cell constant, used to measure the electrochemical properties may be determined.

At 502, a droplet of the reference sample is positioned between the upper surface (with the first electrode 110) and the lower surface (with the second electrode 111) with the surfaces positioned at the volume determining position. The surfaces may be positioned at the volume determining position by operating the actuators according to the pedestal lookup table. The sample may be loaded to the liquid analysis system with the same pipette used in the calibration process (304 of FIG. 3).

At block 504, one or more sample images of the reference sample positioned between the surfaces of the pedestals are captured. For example, the controller 106 may instruct the camera 108 to capture the sample images.

At block 506, the captured sample images of the micro-liquid calibration droplet are compared against a library of reference volume images in a volume library. The volume library contains images of droplets of known volumes placed between the pedestals.

The acquired sample image may be compared with reference volume images to find the reference volume image that best matches the geometry or shape of the acquired droplet image. Similar to step 404 in FIG. 4, various image processing methods may be used for matching the acquired sample image with the reference volume images.

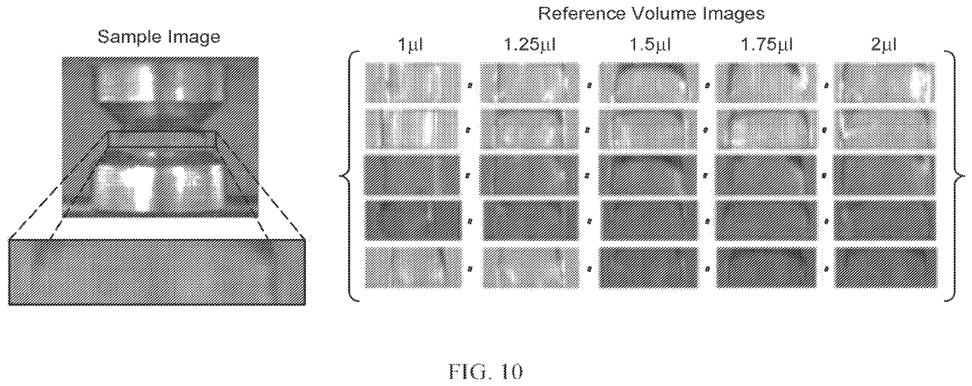

FIG. 10 illustrates a sample image of a droplet of 2 microliter volume comparing to a set of reference volume images. The droplet in the sample image may be segmented out for the comparison. For this example, the reference volume images include reference images of drops having volumes of 1 microliter, 1.25 microliter, 1.5 microliter, 1.75 microliter, and 2 microliters, wherein each image was taken at a single fixed pedestal position (separation distance). For a particular volume, the reference volume images may be taken of different droplets/samples to account for the variance in positioning/placement/geometry the of droplets. The reference volume images may also include images of droplets taken at different lighting conditions.

In this example, each of sample images are cropped to capture only the bubble of solution and without any part of the pedestal. The reference volume images also only include the sample without the pedestal. The cropped image of the drop of unknown volume serves as the kernel and the reference volume image taken from volume library serves as the larger image in the calculation of the correlation matrix.

In some examples, machine learning or a neural network could be trained to identify droplets of solutions in captured images and find a volume.

At 508, the controller 106 determines the sample volume based on a volume associated with the volume reference image matching the captured sample image at 502. The degree of matching can be quantitively determined for example based on the structural similarity index or the correlation coefficient. In some examples, the sample volume may be estimated by interpolating the volumes associated with several good matching volume reference images.

A measurement position may be determined based on the determined sample volume. The measurement position may alternatively be presented in the form of pedestal separation. The measurement position (or the measurement separation distance) may be one of the measurement positions (or measurement separation distances) in the pedestal library. The selection may be based on a lookup table that stores the optimal measurement position for each of multiple sample volumes. For example, depending on the configuration of the instrument, 7000 motor steps may be equivalent to 0.68 millimeters in distance between the two pedestals, 8000 motor steps may be equivalent to 0.476 millimeters in distance between the two pedestals, and 9000 motor steps may be equivalent to 0.306 millimeters in distance between the two pedestals. When the surfaces are arranged in a horizontal orientation (see, e.g., FIG. 1A), pedestal separation may be defined as the distance between the bottom of the top (upper) pedestal and the top of the bottom (lower) pedestal.

In some examples, steps 502-506 may be skipped, and a user inputted sample volume will be used for selecting the measurement position.

At 510, parameters for the electrochemical properties are determined. For example, the surface positions are adjusted to the selected measurement position at 508, and the AC signals are applied across the reference sample. The electrical signals are received via the electrodes integrated into the surface and used to calculate the resistivity of the reference sample. Based on a measured voltage across the sample, the known conductivity of the reference sample, and the know parameters of the applied AC signal, cell constant may be calculated based on Equation 1. The controller 16 may store the determined cell constant for later use during the measurement process at 306 of FIG. 3. In one example, a salt solution with a conductivity near 750 S/cm can be used as a reference solution. The cell constant can be set according to a reference at a given temperature (e.g., 20 °C) so that conductivity measurements done on samples can be reported referenced to this temperature.

A signal generator can be coupled to the electrodes via one or more wires, electrical conduits, or other electrical connections or circuitry. In one example, the AC voltages are applied to the reference sample and read from the pedestals via the electrodes using an Analog Devices CN-0359 board. Software or firmware associated with this board can be configured to translate the inputted and outputted voltages directly into conductivity values.

The AC signals may be applied by any waveform-generating device that can produce either repetitive bi-polar AC waveform (e.g., at 6 kHz oscillation frequency with a peak-to-peak voltage between 1V and 3V). Likewise, a device such as a high-frequency RMS multimeter or high-speed analog-to-digital converter can be used to translate the voltages present across the pedestals into the values for calculating conductivity. In some embodiments, the voltage on each pedestal periodically varies during the measurement process. In particular, while applying the AC signal, charge moves back-and-forth between the pedestals, which prevents ions from preferentially moving towards one electrode or the other.

By collecting images of the droplet combined with image analysis, the system self-optimizes to accurately measure the solution's conductivity in droplet form. The workflow presented herein recognizes that the accurate measurement of a microliter droplet's electrochemical property depends on the geometry of the drop while suspended between the two surfaces/electrodes. For example, regardless of the volume of the droplet, when the droplet occupies a bubble-like geometry, more accurate measurements of conductivity may be obtained as compared to droplets in other geometries. By setting the surfaces at the selected measurement position during the measurement process (306 of FIG. 3), the geometry of the droplet volume is controlled and electrochemical properties can be accurately measured.

FIG. 6 is a flow chart of method 600, which is an example of the measurement process 306 of FIG. 3. Method 600 measures the electrochemical properties of a sample suspended between two surfaces. The electrodes are integrated in the surfaces of the pedestals for receiving electrical signals.

At 602, a sample of interest is loaded into the calibrated liquid analysis device system 100 or 200 (i.e., with the surfaces 103 and 104 positioned at the determined measurement separation distance). In some embodiments, the sample is loaded with the same pipette, with the same setting, as used in the calibration process 304. In some embodiments, the controller 106 displays a communication on, for example, a display, instructing a user to load the sample of a micro-liquid of interest between the upper surface 103 and the lower surface 104. The controller 106 adjusts the separation distance between the upper surface 103 and the lower surface 104 to the selected measurement separation distance that corresponds to the sample volume. The controller 106 may communicate with the actuator 112 to adjust at least one of the upper surface 103 and the lower surface 104, such that a separation distance between the upper surface 103 and the lower surface 104 corresponds to the measurement separation distance that corresponds with the determined volume.

At 604, an electrical signal is applied to the sample of the micro-liquid of interest. The controller 106 may communicate with the electronic processing unit 113 to apply the electrical signal. The electrical signal may be an AC signal as described in 510 of FIG. 5.

At 606, an electrical resistivity of the sample of the micro-liquid of interest is measured responsive to the applied electrical signal. For example, the controller 106 may receive electrical measurements from one or both of the electrodes 110 and 111, which the controller 106 uses (with the known applied electrical signal) to measure the electrical resistivity of the sample.

At 608, an electrochemical property of the sample of the micro-liquid of interest is determined based on, at least, the measured electrical resistivity of the sample of the micro-liquid of interest and the cell constant determined at the calibration process. For example, the controller 106 may determine the conductivity of the sample of interest based on the electrical resistivity of the sample, such as, for example, via Equation 1, as described at 510 of FIG. 5. For example, a voltage drop can be measured over the sample solution and a resistor (with a known resistance) positioned in series with the circuit formed through the solution can be used to determine a value of a current passing through the solution, wherein the voltage value and the current value can be used to determine the sample's resistivity.

In some examples, step 604 may be skipped, and the pH level may be estimated at 608 based on electrical signals received via the electrodes in an open circuit.

In some embodiments, the controller 106 displays a communication on, for example, a display, informing the user of the determined electrochemical property of the sample of the micro-liquid of interest. Alternatively, or in addition, the controller 106 may output the determined electrochemical properties to one or more external devices, networks, or data storage devices. The data may be provided in raw form, as part of a report, or a combination thereof. One or more alerts may also be generated based on the determined electrochemical property, such as, for example, to warn a user of an error, an out-of-range conductivity, or the like.

If another sample needs to be measured, the new sample of interest may be loaded to the system using the same pipette and the measurement can be done by repeating method 600 without re-calibrating the system. If sample at a different volume needs to be analyzed, a new calibration process (304 of FIG. 3) may be performed.

As described herein, in some embodiments, the volume of the drop of solution for the conductivity measurements is interactively identified to identify the precise separation of the electrodes needed to maintain the drop's geometry, which can improve precision in conductivity measurements on microliter droplets. This method may be completely automated and may combine rapid imaging of the drop, real-time control of the pedestal (electrode) separation, and real-time image processing. In some embodiments, the workflow presented here can determine the conductivity of a microliter droplet within less than 5 seconds of the droplet being placed on the pedestal. It should be understood that other methods of determining a sample volume can be used with the systems described herein. For example, in some embodiments, the instrument may be configured for one default volume and may rely on proper depositing of an appropriate sample. In other embodiments, user input (received through one or more user interfaces of the instrument or a separate device communicating with the instrument) may specify a volume of a deposited sample. These techniques, however, may not accurately reflect the true volume of a sample and, thus, in some embodiments, the workflow described herein may provide improved results over using default or user-specified volumes.

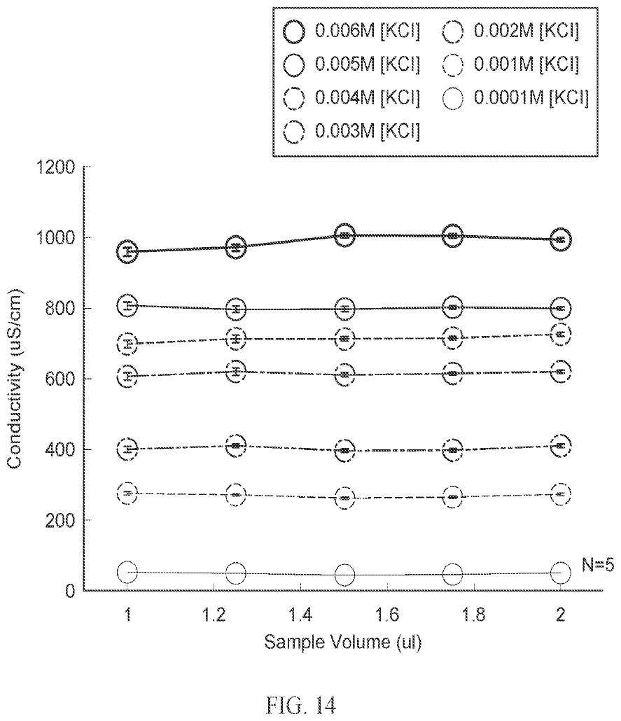

FIG. 14 shows the measured conductivities of droplets of KCl solutions with volumes between 1 microliter and 2 microliters, using the method presented herein. The measured conductivities from ranging from 50 μS/cm to 1000 μS/cm. The measured conductivity of each concentration of KCl is relatively constant regardless of the change in droplet volume.

Accordingly, the methods and systems described herein make measurements of conductivity on microliter volumes routine, inexpensive, and widely accessible. For example, as a readout of possible contamination, measurements of conductivity of DNA may be used to ensure proper storage and run-time conditions for running gels, staining protocols, and electroporation.

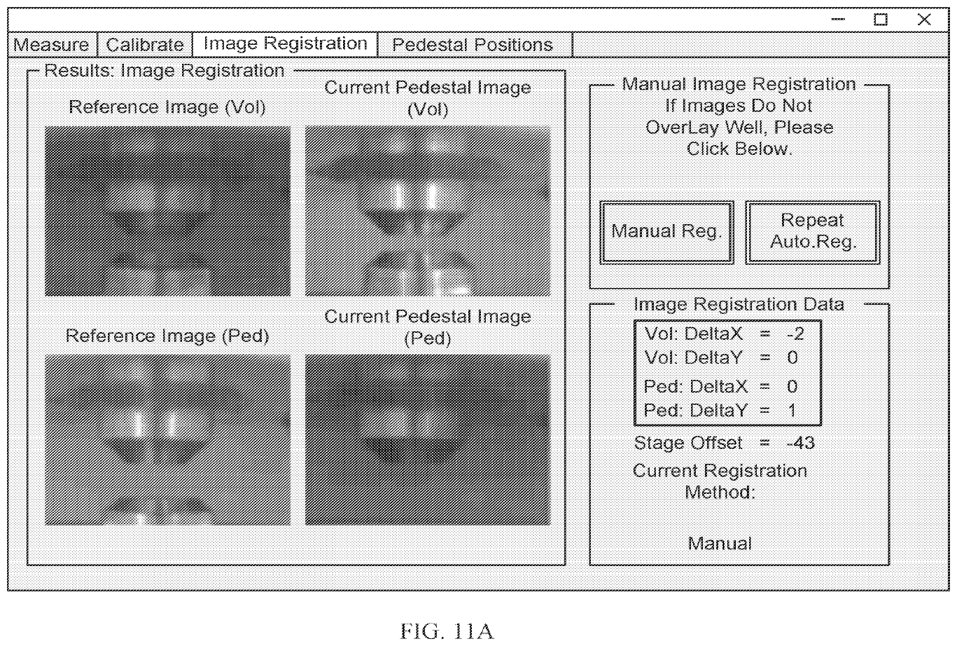

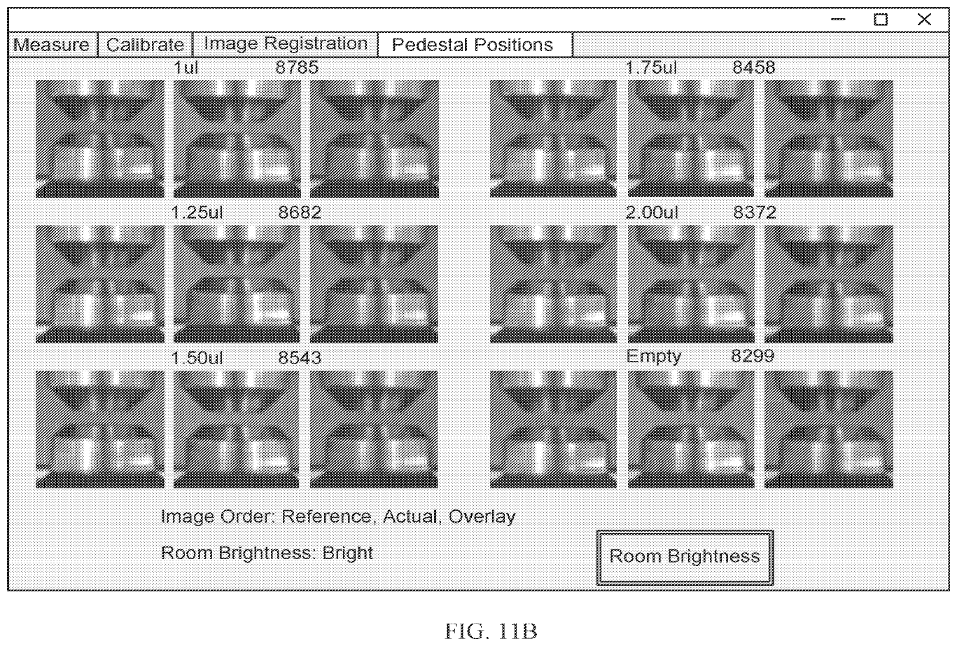

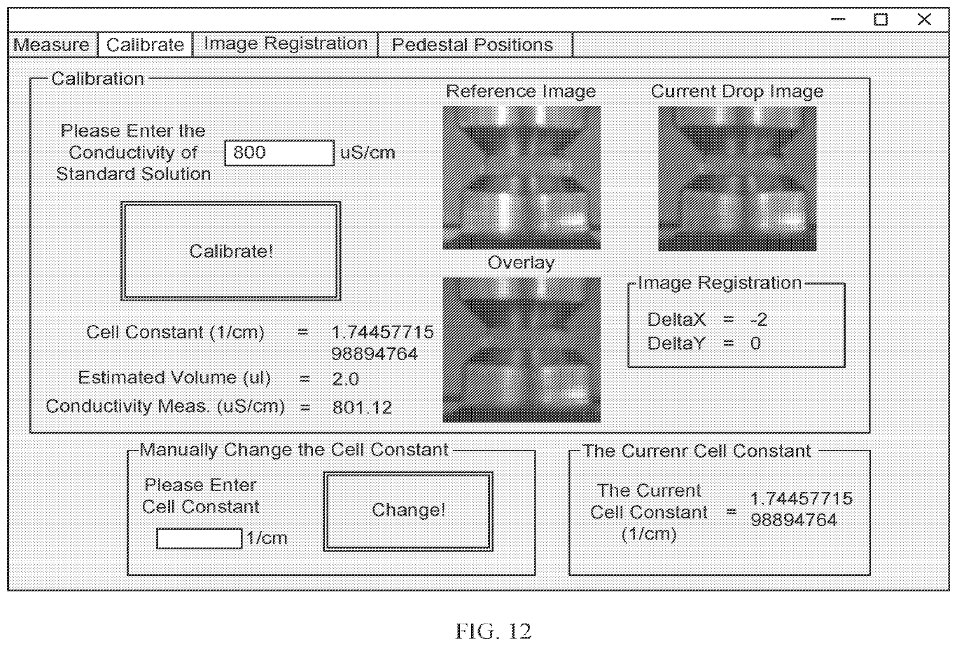

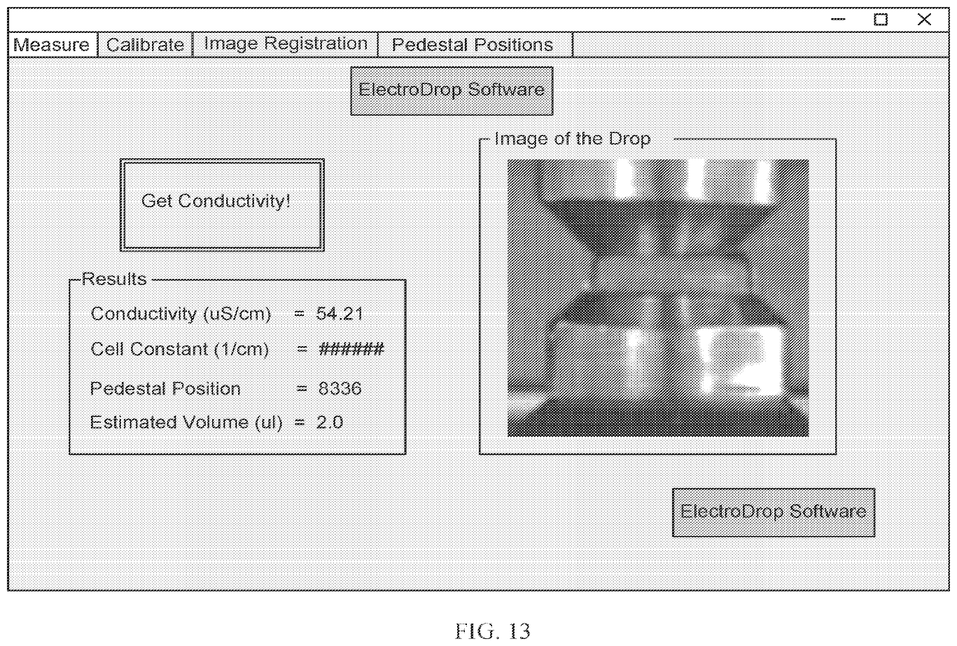

In one non-limiting example of the method and system described herein is provided below. In this example, the conductivities of droplets of KCl (salt) solutions (having a conductivity of 800 μS/cm) were measured on an instrument (e.g., the NanoDrop One™) where the pedestals were connected to the electrode inputs on the CN-0359 (conductivity) board. Components of the system including the pedestals, the camera on the instrument, and the CN-0359 board were controlled with a GUI-based program shown in FIGS. 11A-B and FIGS. 12-13.

After the program is initially executed, an automated image registration method engages and aligns the position of the top pedestal taken from real-time images on the instrument to the reference pedestal image. The outputs from the image registration are the difference in x (referred to as dx) and the difference in y (referred to as dy). FIGS. 11A and 11B illustrate image registration and locating positions, wherein FIG. 11A illustrates a GUI's Image Registration tab, wherein the changes in x and y coordinates calculated using the automated image registration are shown in the boxed area. FIG. 11B illustrates a Pedestal Positions tab, wherein images from the pedestal library (reference pedestal images) are shown with the acquired pedestal images and overlays so that the accuracy of the image registration can be observed and assessed.

After the image registration is complete, the program automatically detects one or more (e.g., six) relevant pedestal separations needed for measurements (i.e., measurement positions). As shown in FIG. 11B, in response to both the image registration and steps to locate the necessary stage positions completing successfully, the overlays of the reference and acquired images for each pedestal separation does not show any mismatch. However, if any mismatch does exist, the manual image registration method can be used to provide correction. In this case, the overlay images of the needed pedestal position indicate that the system has initialized properly. Accordingly, as described above, during the initialization process, a series of reference pedestal images and acquired pedestal images (of the empty pedestals) are compared to locate the pedestal separations used to measure the conductivity for specific volumes. These separations are stored in software (e.g., in a look-up table or other type of data structure), such as, for example, in units of motor steps. These motor steps may vary over time or from instrument to instrument, which is why each initialization process may check for the appropriate motor steps for a set of usable separation distances.

Next, a droplet of a calibration solution is positioned onto the instrument (between the pedestals). FIG. 12 shows the GUI for the calibration process, which may be displayed by selecting the “Calibrate” tab. The conductivity of the reference (or standard) solution is shown. The conductivity may be entered by the user or automatically withdraw from a database. A user presses the “Calibrate” button. In response to the “Calibrate” button being pressed, the pedestals on the instrument automatically move to the positions needed to calculate the volume of drop (using the motor steps determined during the initialization). For example, as described above, in some embodiments, a single pedestal separation is used to determine the volume of any drop placed on the pedestal during this calibration step. Sample images of the droplet are acquired and similarity calculations are performed, which yields the volume of the drop. In response to determining the volume, the pedestal separation moves to the position necessary to measure the conductivity (i.e., the selected measurement position) for the determined volume (again using the motor steps determined during initialization). In some embodiments, two conductivity measurements are taken at two cell constants: for example one with a cell constant of 1 and a separate second one with a cell constant of 2. Using these measurements and the inputted known conductivity of the calibration solution, the cell constant for this system is calculated using, for example, a simple linear fit. One or more of the values calculated during the calibration process, such as, for example, the volume and cell constant can be displayed in the “Calibrate” tab of the GUI, shown in FIG. 12. In addition, images of the current drop being examined, and the reference image selected by the software when determining the volume can also be presented within the GUI.

In the measurement step, a droplet of sample of interest at the same volume as that which the instrument has been calibrated with can be positioned and the user can press the “Get Conductivity” button of FIG. 13 to measure the droplet's conductivity. In the example shown in FIG. 13, a 2-microliter droplet of 0.0001M KCl that was placed on the pedestal had a measured conductivity of μS/cm.

Example 1 A system for analyzing a sample, comprising: a first surface including at least a part of a first electrode; a second surface including at least a part of a second electrode, the second surface positioned opposite the first surface for holding the sample between the first surface and the second surface by surface tension; and an electronic processing unit coupled to at least one of the first electrode and the second electrode for receiving electrical signals from the sample to determine an electrochemical property of the sample.

Example 2 includes the subject matter of any of Examples 1, and further specifies that the electrochemical property of the sample includes a pH level of the sample.

Example 3 includes the subject matter of any of Examples 1, and further specifies that the electrochemical property of the sample includes a conductivity of the sample.

Example 4 includes the subject matter of any of Examples 3, and further specifies that the system further comprises an electrical signal generator electrically coupled to at least one of the first electrode and the second electrode for applying a second electrical signal across the sample held between the first surface and the second surface.

Example 5 includes the subject matter of any of Examples 1-6, and further specifies that the sample is in direct contact with both the first electrode and the second electrode.

Example 6 includes the subject matter of any of Examples 1, and further specifies that the first and second surfaces are flat and positioned horizontally.

Example 7 includes the subject matter of any of Examples 1-6, and further includes an actuator for moving at least one of the first and second surfaces to adjust a distance between the first and second surfaces.

Example 8 includes the subject matter of any of Examples 1-7, and further includes a camera to acquire an image of the sample held between the first and second surfaces.

Example 9 includes the subject matter of any of Examples 8, and further specifies that the image includes both at least a part of the first surface and at least a part of the second surface.

Example 10 includes the subject matter of any of Examples 1-9, and further specifies that at least one of the first surface and the second surface is hydrophobic.

Example 11 includes the subject matter of any of Examples 1-10, and further includes: a first optical fiber integrated with the second surface; and a second optical fiber integrated with the first surface, wherein one of the first and second optical fibers radiating light through the sample and the other optical fiber collecting the light transmitted through the sample.

Example 12. A method for measuring an electrochemical property of a sample, comprising: positioning the sample between a first surface and a second surface, wherein the sample is held between the first and second surfaces via surface tension, and a least an electrically conductive part of each of the first surface and the second surface is in direct contact with the sample; receiving electrical signals from the sample at the electrically conductive part of at least one of the first surface and the second surface; and determining the electrochemical property of the sample based on the received electrical signals.

Example 13 includes the subject matter of any of Examples 12, and further includes applying a second electrical signal across the sample while receiving electrical signals from the sample.

Example 14 includes the subject matter of any of Examples 13, and further specifies that applying the electrical signal across the sample includes applying an AC signal across the sample via the electrically conductive parts of the first and second surfaces.

Example 15 includes the subject matter of any of Examples 13, and further specifies that determining the electrochemical property of the sample based on the received electrical signal includes: measuring a resistance of the sample responsive to the applied electrical signal, and determining an electrical conductivity based on the resistance.

Example 16 includes the subject matter of any of Examples 12-15, and further includes determining the measurement separation distance based on a volume of the sample, and adjusting a distance between the first surface and the second surface to a measurement separation distance before receiving the electrical signals from the sample.

Example 17 includes the subject matter of any of Examples 16, and further includes receiving the volume of the sample from user input.

Example 18 includes the subject matter of any of Examples 16, and further includes: adjusting the distance between the first and second surfaces to a calibration separation distance; acquiring an image of a reference sample positioned between the first and second surfaces; and determining the volume of the sample based on the image of the reference sample.

Example 19. The method of claim 18, and further specifies that determining the volume of the sample based on the image of the reference sample includes: determining a reference volume by comparing the image of the reference sample with at least one of multiple reference volume images; and determining the volume of the sample based on the reference volume.

Example 20 includes the subject matter of any of Examples 19, and further specifies that comparing the image of the reference sample with the at least one of the multiple reference volume images includes comparing a geometry of the reference sample in the image of the reference sample with a geometry of a sample in the at least one of the multiple reference volume images.

Example 21 includes the subject matter of any of Examples 12-20, and further includes detecting an optical property of the sample positioned between the first surface and the second surface.

Example 22 includes the subject matter of any of Examples 12-21, and further includes:
calibrating pedestal position before positioning the sample between the first surface and the second surface.

Example 23 includes the subject matter of any of Examples 22, and further specifies that calibrating pedestal position includes adjusting the distance between the first surface and the second surface by setting an actuator coupled to one or more of the first and second surfaces to a starting position for a predetermined separation distance; acquiring at least one pedestal image including at least one of the first surface and the second surface; comparing the pedestal image with a reference pedestal image associated with the predetermined separation distance; and in response to the pedestal image matching the reference pedestal image, storing the starting position associated with the predetermined separation distance.

Example 24 includes the subject matter of any of Examples 12-23, and further includes positioning a reference sample between the first and second surfaces; adjusting the distance between the first surface and the second surface to the measurement separation distance; receiving electrical signals from the reference sample at the electrically conductive part of at least one of the first surface and the second surface; determining at least a parameter for calculating the electrochemical property; and calculating the electrochemical property of the sample based on the parameter.

Example 25 includes the subject matter of any of Examples 24, and further specifies that the at least a parameter includes cell constant and the electrochemical property includes conductivity.

Example 26 includes the subject matter of any of Examples 25, and further specifies that the electrical signals from the reference sample were received while applying voltages across the reference sample.

Example 27. A system for analyzing a liquid sample, comprising: a first surface including at least a part of a first electrode; a second surface including at least a part of a second electrode, the second surface positioned opposite the first surface for holding a volume liquid sample between the first surface and the second surface by surface tension; an actuator for adjusting a distance between the first surface and the second surface; a controller including a processor and a non-transitory memory for storing computer readable instructions, by executing the instructions in the processor, the controller is configured to: adjust, via the actuator, the distance between the first surface and the second surface to a measurement separation distance; receive an electrical signal from the liquid sample; and determine an electrochemical property of the sample based on the received electrical signal.

Example 28 includes the subject matter of any of Examples 27, and further specifies that the electrochemical property is a pH level of the liquid sample.

Example 29 includes the subject matter of any of Examples 28, and further specifies that a portion of the first surface is coated with metal oxide and a portion of the second surface is coated with silver chloride (AgCl).

Example 30 includes the subject matter of any of Examples 28-29, and further specifies that receiving electrical signals includes detecting an open circuit voltage.

Example 31 includes the subject matter of any of Examples 27, and further specifies that the electrochemical property is a conductivity of the liquid sample.

Example 32 includes the subject matter of any of Examples 31, and further includes a signal generator electrically coupled to at least one of the first electrode and the second electrode for applying electrical signals across the liquid sample.

The above-indicated and possibly some other related problems in the state of the art can beneficially be addressed using various examples, aspects, features, and embodiments of systems and methods for image analysis disclosed herein. Accordingly, incorporating image analysis into a system and method for measuring electrochemical properties of a liquid sample creates technological problems embodiments described herein solve through particular computing systems and devices and image analysis. Thus, embodiments, disclosed herein provide improvements to measurements of electrochemical properties of liquid samples (e.g., improvements in the computer technology supporting such measuring functionality, among other improvements).

As described above in the detailed description, reference is made to the accompanying drawings that form a part hereof wherein like numerals designate like parts throughout, and in which is shown, by way of illustration, embodiments that may be practiced. It is to be understood that other embodiments may be utilized, and structured or logical changes may be made, without departing form the scope of the present disclosure. Therefore, detailed description as described above is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purpose of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), or (A, B, and C). Although some elements may be referred to in the singular (e.g., “a processing device”), any appropriate elements may be represented by multiple instances of that elements, and vice versa. For example, a set of operations described as performed by a processing device may be implemented with different ones of the operations performed by different processing devices.

The description uses the phrases “an embodiments,” “various embodiments,” and “some embodiments,” each of which may refer to one or more of the same or different embodiments. Furthermore, the terms “comprising,” “including,” “having,” and the like, as used with respect to embodiments of the present disclosure, are synonyms. When used to describe a range of values, the phrase “between X and Y” represents a range that includes X and Y. As used herein, an “apparatus” and/or “system” may refer to any individual device, collection of devices, part of a device, or collections of parts of devices. The drawings are not necessarily to scale.

1. A system for analyzing a sample, comprising:
a first surface including at least a part of a first electrode;
a second surface including at least a part of a second electrode, the second surface positioned opposite the first surface for holding the sample between the first surface and the second surface by surface tension; and
an electronic processing unit coupled to at least one of the first electrode and the second electrode for receiving electrical signals from the sample to determine an electrochemical property of the sample.

2. The system of claim 1, wherein the electrochemical property of the sample includes a pH level of the sample.

3. The system of claim 1, wherein the electrochemical property of the sample includes a conductivity of the sample.

4. The system of claim 3, wherein the system further comprises an electrical signal generator electrically coupled to at least one of the first electrode and the second electrode for applying a second electrical signal across the sample held between the first surface and the second surface.

5. The system of claim 1, wherein the sample is in direct contact with both the first electrode and the second electrode.

6. (canceled)

7. The system of claim 1, further comprising an actuator for moving at least one of the first and second surfaces to adjust a distance between the first and second surfaces.

8. The system of claim 1, further comprising a camera to acquire an image of the sample held between the first and second surfaces.

9-10. (canceled)

11. The system of claim 1, further comprising:
a first optical fiber integrated with the second surface; and
a second optical fiber integrated with the first surface, wherein one of the first and second optical fibers radiating light through the sample and the other optical fiber collecting the light transmitted through the sample.

12. A method for measuring an electrochemical property of a sample, comprising:
positioning the sample between a first surface and a second surface, wherein the sample is held between the first and second surfaces via surface tension, and a least an electrically conductive part of each of the first surface and the second surface is in direct contact with the sample;
receiving electrical signals from the sample at the electrically conductive part of at least one of the first surface and the second surface; and
determining the electrochemical property of the sample based on the received electrical signals.

13. The method of claim 12, further comprising applying a second electrical signal across the sample while receiving electrical signals from the sample.

14. The method of claim 13, wherein applying the electrical signal across the sample includes applying an AC signal across the sample via the electrically conductive parts of the first and second surfaces.

15. The method of claim 13, wherein determining the electrochemical property of the sample based on the received electrical signal includes: measuring a resistance of the sample responsive to the applied electrical signal, and determining an electrical conductivity based on the resistance.

16. The method of claim 12, further comprising determining the measurement separation distance based on a volume of the sample, and adjusting a distance between the first surface and the second surface to a measurement separation distance before receiving the electrical signals from the sample.

17. (canceled)

18. The method of claim 16, further comprising:
adjusting the distance between the first and second surfaces to a calibration separation distance;
acquiring an image of a reference sample positioned between the first and second surfaces; and
determining the volume of the sample based on the image of the reference sample.

19. (canceled)

20. The method of claim 19, wherein comparing the image of the reference sample with the at least one of the multiple reference volume images includes comparing a geometry of the reference sample in the image of the reference sample with a geometry of a sample in the at least one of the multiple reference volume images.

21. The method of claim 12, further comprising detecting an optical property of the sample positioned between the first surface and the second surface.

22. (canceled)

23. The method of claim 12, further comprising calibrating pedestal position by adjusting the distance between the first surface and the second surface by setting an actuator coupled to one or more of the first and second surfaces to a starting position for a predetermined separation distance;
acquiring at least one pedestal image including at least one of the first surface and the second surface; comparing the pedestal image with a reference pedestal image associated with the predetermined separation distance; and
in response to the pedestal image matching the reference pedestal image, storing the starting position associated with the predetermined separation distance.

24. The method of claim 12, further comprising:
positioning a reference sample between the first and second surfaces;
adjusting the distance between the first surface and the second surface to the measurement separation distance;
receiving electrical signals from the reference sample at the electrically conductive part of at least one of the first surface and the second surface;
determining at least a parameter for calculating the electrochemical property; and
calculating the electrochemical property of the sample based on the parameter.

25. The method of claim 24, wherein the at least a parameter includes cell constant and the electrochemical property includes conductivity.

26. (canceled)

27. A system for analyzing a liquid sample, comprising:
a first surface including at least a part of a first electrode;
a second surface including at least a part of a second electrode, the second surface positioned opposite the first surface for holding a volume liquid sample between the first surface and the second surface by surface tension;
an actuator for adjusting a distance between the first surface and the second surface;
a controller including a processor and a non-transitory memory for storing computer readable instructions, by executing the instructions in the processor, the controller is configured to:
adjust, via the actuator, the distance between the first surface and the second surface to a measurement separation distance;
receive an electrical signal from the liquid sample; and
determine an electrochemical property of the sample based on the received electrical signal.

28. The system of claim 27, wherein the electrochemical property is a pH level of the liquid sample, wherein a portion of the first surface is coated with metal oxide and a portion of the second surface is coated with silver chloride (AgCl), and wherein receiving electrical signals includes detecting an open circuit voltage.

29-30. (canceled)

31. The system of claim 27, further comprising a signal generator electrically coupled to at least one of the first electrode and the second electrode for applying electrical signals across the liquid sample, wherein the electrochemical property is a conductivity of the liquid sample.

32. (canceled)
